(19) United States
(12) Patent Application Publication
(10) Pub. No.: US 2019/0236966 A1
(43) Pub. Date: Aug. 1, 2019

(54) CENTRALIZED REGISTRY FOR UNMANNED VEHICLE TRAFFIC MANAGEMENT

(71) Applicant: General Electric Company, Schenectady, NY (US)

(72) Inventors: Szabolcs BORGYOS, Grand Rapids, MI (US); Susan ROBERTS, Grand Rapids, MI (US); Vineet MEHTA, Boston, MA (US); John SPIRTOS, Boston, MA (US); Ashish JAIN, Bridgewater, NJ (US)

(21) Appl. No.: 15/884,970

(22) Filed: Jan. 31, 2018

(51) Int. Cl. G08G 9/02; G05D 1/00; G08G 7/02; G05D 1/10

(52) U.S. Cl. CPC G08G 9/02; G05D 1/10; G08G 7/02; G05D 1/0044

(57) ABSTRACT

According to some embodiments, a centralized registry data store may contain electronic records that represent movement plan contracts for Unmanned Vehicles (“UVs”). A centralized registry platform may receive information about a potential movement plan contract for a UV and dynamically create a potential multi-dimensional, time-indexed volume representing the potential movement plan contract. The centralized registry platform may then automatically compare the potential multi-dimensional, time-indexed volume with another volume representing another movement plan contract that was previously registered with the centralized registry platform. Based on a result of the comparison, the centralized registry platform may dynamically register the potential movement plan contract in the centralized registry data store.

### BACKGROUND

Some embodiments disclosed herein relate to unmanned vehicles and, more particularly, to systems and methods implementing or using a centralized registry to manage unmanned vehicle traffic.

Unmanned vehicles (“UVs”), such as autonomous automobiles, drones or pilotless aircraft, cargo ships, and submarines, have several commercial and consumer uses (e.g., package delivery, imaging, or long-range inspection). It may be important, however, to coordinate the movement paths of multiple UVs with respect to each other, with respect to restricted airspace (e.g., around an airport), with respect to piloted aircraft, etc. Note that the utility offered by UVs may need to be balanced with the risk inherent in automated systems moving near people, other vehicles, and property. Manually coordinating UV traffic can be a complex and error-prone task, especially there are a substantial number of vehicles.

One approach to coordinating this type of traffic would be to have UVs communicate with each other to avoid collisions. Similarly, every UV might be equipped to radar or similar sensors to detect and locally avoid other UVs. Although these types of systems are possible, widespread implementation may be unlikely due to safety concerns. For example, all UVs would need to be fully equipped with the appropriate hardware and software components providing sense-and-avoid functionality, and failure of any of the devices could lead to dangerous situations.

It may therefore be desirable to achieve improved and computerized ways to efficiently and accurately facilitate management of unmanned aerial system traffic.

### SUMMARY

According to some embodiments, a centralized registry data store may contain electronic records that represent movement plan contracts for a UV. A centralized registry platform may receive information about a potential movement plan contract for a UV and dynamically create a potential multi-dimensional, time-indexed “volume” representing the potential movement plan contract. As used herein, the term “volume” may in some cases refer to an area (e.g., when the UV is associated with an autonomous vehicle or cargo ship). The centralized registry platform may then automatically compare the potential multi-dimensional, time-indexed volume with another volume representing another movement plan contract that was previously registered with the centralized registry platform. Based on a result of the comparison, the centralized registry platform may dynamically register the potential movement plan contract in the centralized registry data store.

Some embodiments comprise: means for receiving information about a potential movement plan contract for a UV; means for dynamically creating a potential multi-dimensional, time-indexed volume representing the potential movement plan contract; means for automatically comparing the potential multi-dimensional, time-indexed volume with another volume representing another movement plan contract that was previously registered with the centralized registry platform; and, based on a result of the comparison, means for dynamically registering the potential movement plan contract in the centralized registry data store, wherein the centralized registry data store contains electronic records that represent movement plan contracts for UVs.

Technical effects of some embodiments of the invention are improved and computerized ways to efficiently and accurately facilitate management of unmanned vehicle traffic. With these and other advantages and features that will become hereinafter apparent, a more complete understanding of the nature of the invention can be obtained by referring to the following detailed description and to the drawings appended hereto.

### BRIEF DESCRIPTION OF THE DRAWINGS

FIG. 1 is a high-level diagram of a system according to some embodiments.

FIG. 2 is a method in accordance with some embodiments.

FIGS. 3 through 5 illustrate interactive user displays according to some embodiments.

FIG. 6 is a registry system schematic in accordance with some embodiments.

FIG. 7 is a system with a movement planning module according to some embodiments.

FIG. 8 is a movement planning method in accordance with some embodiments.

FIG. 9 is a system with a movement monitoring module according to some embodiments.

FIG. 10 is a movement monitoring method in accordance with some embodiments.

FIG. 11 is a system with an airspace planning module according to some embodiments.

FIG. 12 is an airspace planning method in accordance with some embodiments.

FIG. 13 illustrates a platform according to some embodiments.

FIG. 14 is a portion of a centralized database in accordance with some embodiments.

FIG. 15 is a system utilizing federated deployment according to some embodiments.

FIG. 16 illustrates a tablet computer providing a display according to some embodiments.

### DETAILED DESCRIPTION

In the following detailed description, numerous specific details are set forth in order to provide a thorough understanding of embodiments. However, it will be understood by those of ordinary skill in the art that the embodiments may be practiced without these specific details. In other instances, well-known methods, procedures, components and circuits have not been described in detail so as not to obscure the embodiments.

One or more specific embodiments of the present invention will be described below. In an effort to provide a concise description of these embodiments, all features of an actual implementation may not be described in the specification. It should be appreciated that in the development of any such actual implementation, as in any engineering or design project, numerous implementation-specific decisions must be made to achieve the developers' specific goals, such as compliance with system-related and business-related constraints, which may vary from one implementation to another. Moreover, it should be appreciated that such a development effort might be complex and time consuming, but would nevertheless be a routine undertaking of design, fabrication, and manufacture for those of ordinary skill having the benefit of this disclosure.

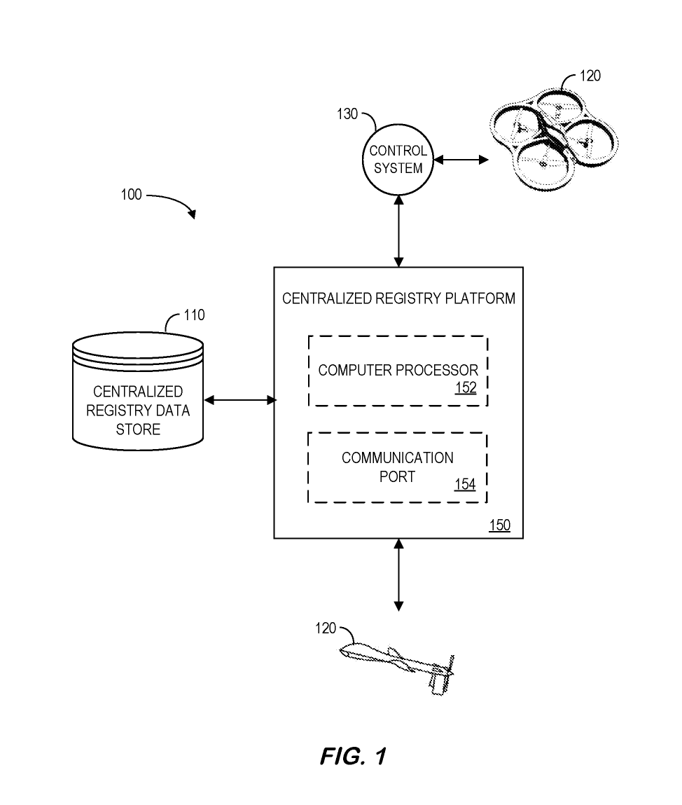

It may therefore be desirable to achieve improved and computerized ways to efficiently and accurately facilitate UV traffic management. For example, FIG. 1 is a high-level diagram of a system 100 according to some embodiments. The system 100 includes a centralized registry platform 150 that communicates with one or more centralized registry data stores 110 and UV 120 (e.g., either directly or via an associated control system 130). According to some embodiments, the centralized registry data store 110 may include electronic records that represent movement plan contracts for UVs. Note that the centralized registry data store 110 could be cloud based in some embodiments or not be cloud based in other embodiments.

The centralized registry platform 150 and/or other elements of the system 100 might be, for example, associated with a Personal Computer (“PC”), laptop computer, a tablet computer, a smartphone, an enterprise server, a server farm, and/or a database or similar storage devices. According to some embodiments, an “automated” centralized registry platform 150 may automatically manage UV traffic. As used herein, the term “automated” may refer to, for example, actions that can be performed with little (or no) intervention by a human.

As used herein, devices, including those associated with the centralized registry platform 150 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The centralized registry platform 150 may store information into and/or retrieve information from data stores, including the centralized registry data store 110. The data stores might, for example, store electronic records representing movement contracts, UV characteristics, operator identifiers, etc. The data stores may be locally stored or reside remote from the centralized registry platform 150. Although a single centralized registry platform 150 is shown in FIG. 1, any number of such devices may be included. Moreover, various devices described herein might be combined according to embodiments of the present invention. For example, in some embodiments, the centralized registry platform 150, centralized registry data store 110, and/or other devices might be co-located and/or may comprise a single apparatus.

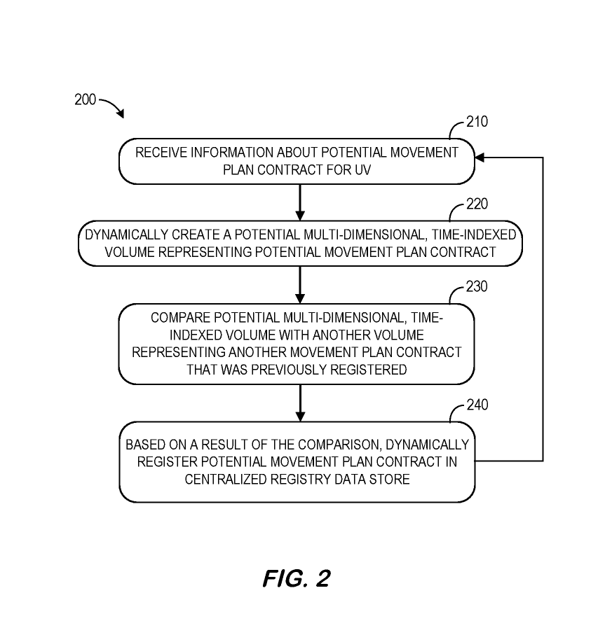

As will be described, the system 100 may efficiently and accurately facilitate management of UV traffic. Note that the system 100 of FIG. 1 is provided only as an example, and embodiments may be associated with additional elements or components. For example, FIG. 2 illustrates a method 200 that might be performed according to some embodiments of the present invention. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At 210, the system may receive information about a potential movement plan contract for a UV (e.g., representing a path the UV plans to travel). For example, a centralized registry platform may receive a potential Unmanned Aerial System (“UAS”), Unmanned Aerial Vehicle (“UAV”), or drone flight plan contract from an operator. According to other embodiments, the UV might be associated with, for example, an autonomous automobile (e.g., a passenger car or truck), cargo ship, submarine, etc.

At 220, the system may dynamically create a potential multi-dimensional, time-indexed volume representing the potential movement plan contract. In the case of an autonomous automobile or cargo ship, for example, the time-indexed volume might be two-dimensional while in the case of a drone or submarine, the time-indexed volume might be three-dimensional. At 230, the system may automatically compare the potential multi-dimensional, time-indexed volume with another volume representing another movement plan contract that was previously registered with the centralized registry platform.

Based on a result of the comparison, at 240 the system may dynamically register the potential movement plan contract in a centralized registry data store. Note that in some embodiments the centralized registry data store may be cloud-based and contain electronic records that represent movement plan contracts for UVs. The dynamically registered movement plan contract might include, for example an operator identifier, an equipment identifier, movement plan locations, an airspace identifier, behavioral attributes (e.g., a minimum or maximum drone speed), etc.

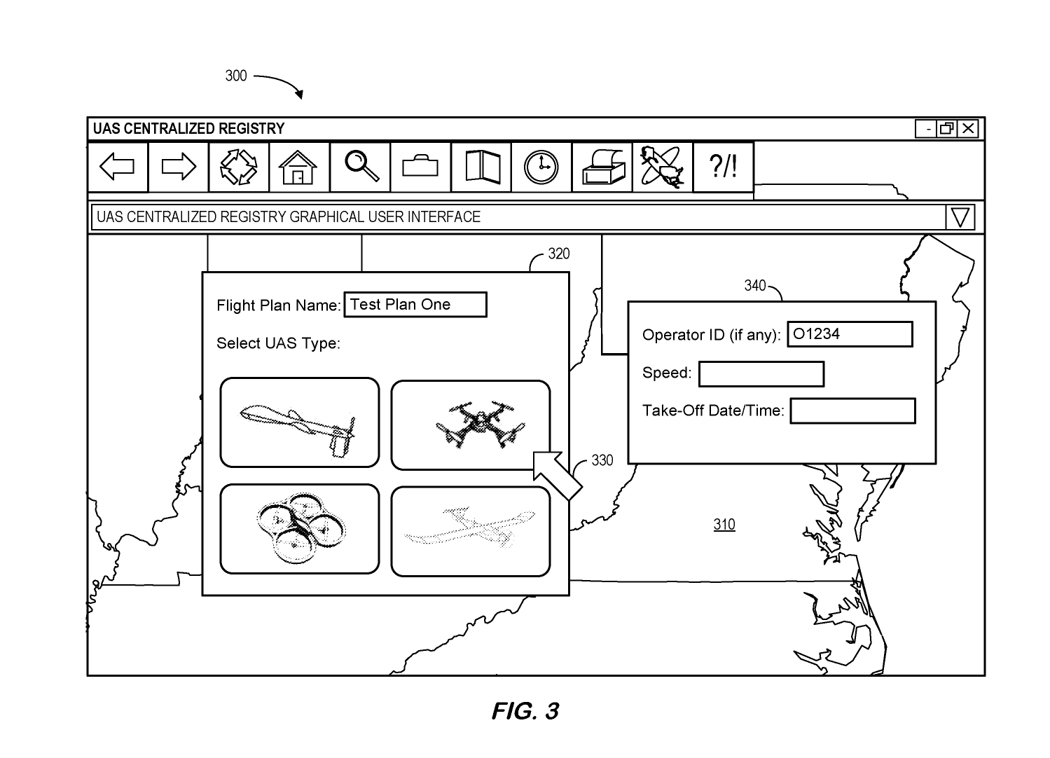

According to some embodiments, the centralized registry may further facilitate validation, in substantially real-time, of consistency of vehicle actions and dynamics relative to registered behavior. For example, FIGS. 3 through 5 illustrate interactive user displays according to some embodiments associated with UAVs or drones. In FIG. 3, an operator might access a display 300 to request a movement plan contract (e.g., a flight plan contact). The display 300 might include a map area 310 (e.g., showing a satellite image or a computer-rendered area). The display 300 may further include a data entry area 320 where the operator may provide a movement plan name and/or select a UV type (e.g., by selecting an icon of the vehicle type via a touchscreen or computer pointer 330). Additional information 340 might also be provided by the operator, such as an operator identifier, a vehicle speed, a take-off date and time, etc.

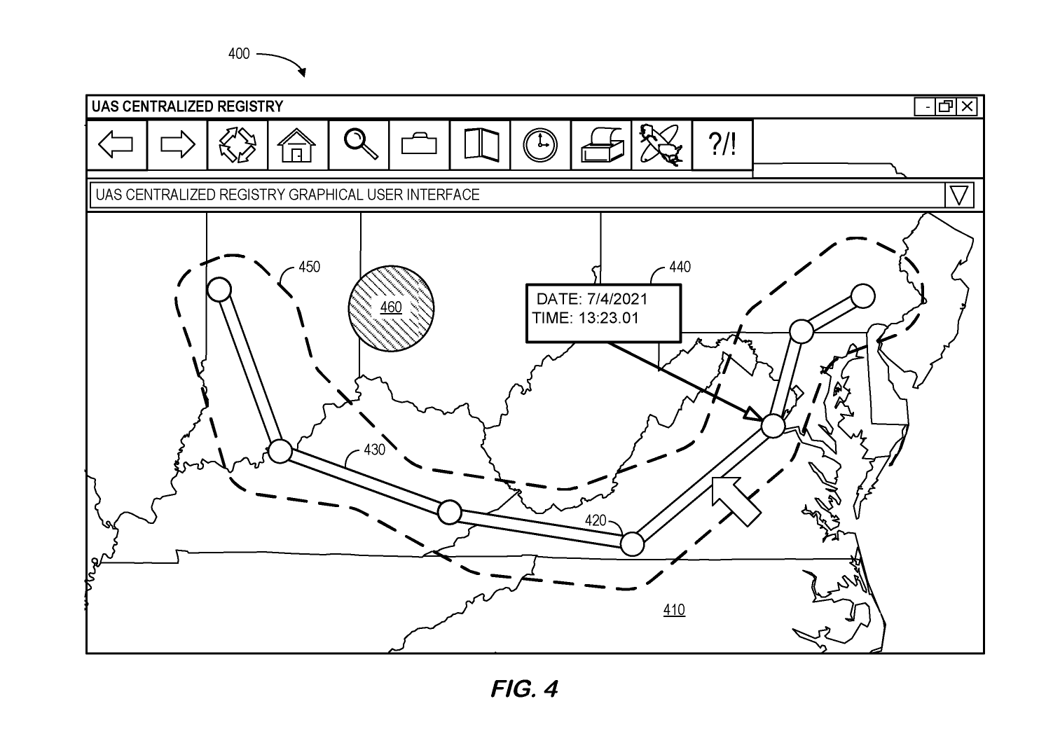

The operator may then use a display 400 such as the one illustrated in FIG. 4 to define a potential movement plan (e.g., a flight plan for a drone) on a map 410. In some cases, the operator might drop a sequential series of destinations or “waypoints” 420 and the system may automatically determine legs 430 of the movement plan between those destinations 420 to define the potential movement plan. According to some embodiments, operator selection of one of those destinations 420 or legs 430 may result in the display of additional information 440 about that element (e.g., an expected time the vehicle will reach a destination 420 assuming a known take-off time and vehicle speed). The system may also dynamically create a potential multi-dimensional, time-indexed volume 450 representing the potential movement plan contract (e.g., a “tube” through which the vehicle is expected to travel). The display 400 may further indicate restricted movement areas 460, such as areas around airports, military installations, etc. In the case of an autonomous automobile, restricted movement areas might be associated with highway construction sites, accidents, etc.

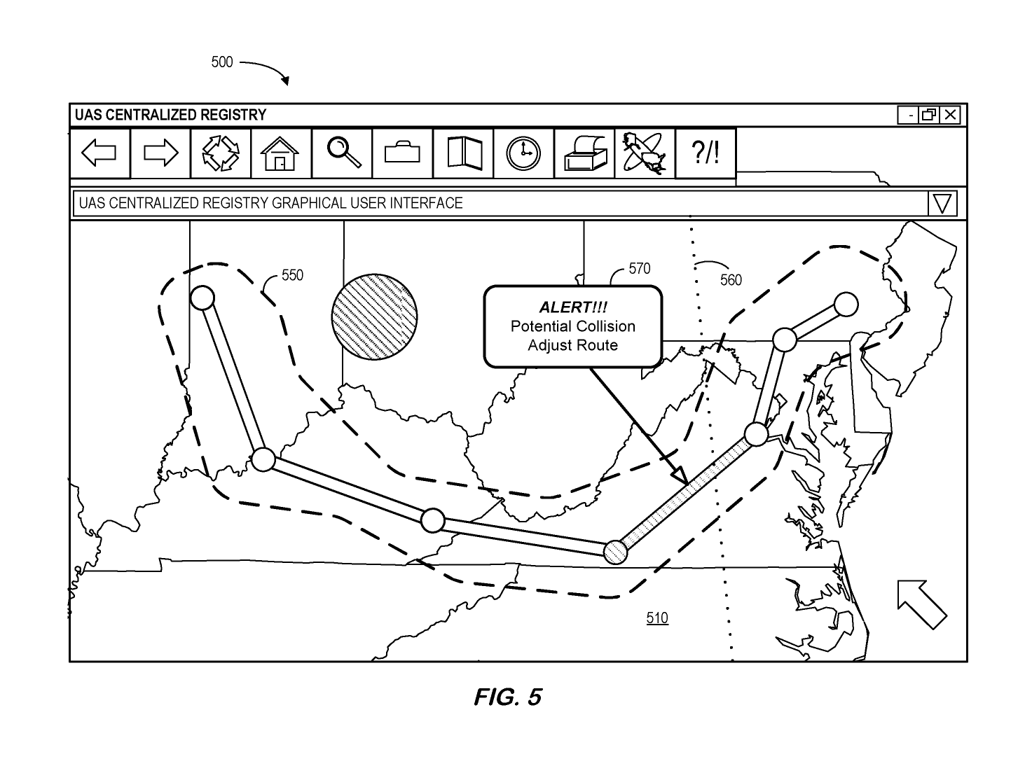

Another display 500 with a map 510 may be presented after the system automatically compares a potential multi-dimensional, time-indexed volume 550 with another volume 560 (e.g., represented by a dotted line in FIG. 5) associated with another movement plan contract that previously registered with a centralized registry platform. If there is a conflict between the two volumes (e.g., two aircraft will fly too close to each other at a particular point in time), an alert 570 may be generated providing details about the conflict, a request that the operator to adjust his or her potential movement plan, an automatically generated suggestion that solves the conflict, etc.

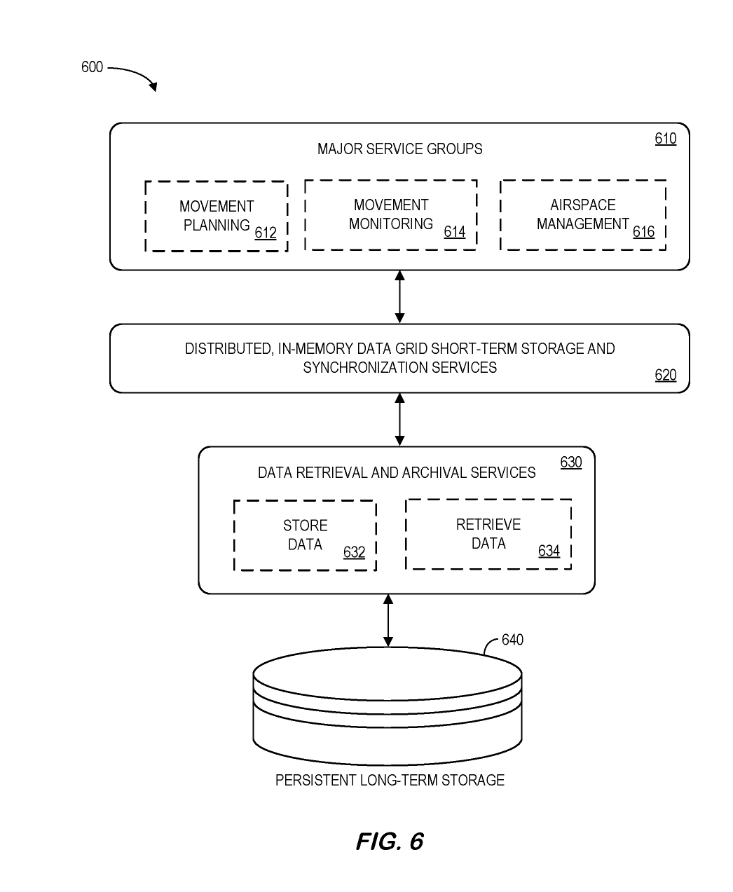

FIG. 6 is a registry system 600 schematic in accordance with some embodiments. The system includes major service groups 610, including a movement planning module 612, a movement monitoring module 614, and an airspace management module 616. The major service groups 610 may access data retrieval and archival services 630 (e.g., to store data 632 and retrieve data 634) via distributed, in memory data grid short-term storage and synchronization services 620. In this way, the major service groups 610 may store data into, and retrieve data from, persistent long-term storage as required.

The distributed in-memory data grid short-term storage and synchronization services 620 may, according to some embodiments, let the system 600 scale and enable inter-service communication using event publish/subscribe interfaces. For example, multiple instance of the movement monitoring module 614 may execute on separate computing machine instances. In some cases, a movement plan request or a telemetry update may get routed to a specific instance of computing machine for processing, and updates made to the data structure by the target machine may be synchronized across other machines that are part of the same registry computing cluster using an in-memory data grid. Similarly, a service may raise (or publish) an event when certain conditions are encountered. That event may be replicated across other machine instances that are part of the registry computing cluster. Any other service that has subscribed to this event may also be notified, irrespective of the machine instance on which the subscriber service is executing.

Note that the in-memory data grid may store various data structures described herein for short-term purposes. To durably persist these data items, the persistent long-term storage 640 may use database systems. Note that various database systems may efficiently index and store this data on computing disks. The system 600 may use the data retrieval and archival services 630 provided by the various database system to execute appropriate queries to move appropriate datasets from the persistent long-term storage 640 to the in-memory grid. Similarly, the system 600 may use appropriate storing services to move the data from the in-memory grid storage to the persistent long-term storage 640.

In this way, embodiments may realize a collaboration for safe unmanned movement operations using logically centralized registry software that executes in a secure cloud computing environment and that provides various services to integrate with software executing on a UV or software executing on a controller system that can interface to a UV (or both). According to some embodiments, three core modules and several data structures may enable registry users to request and register movement plans, in advance or on-demand, monitor movement conformance in real-time, and/or flexibly manage airspace as a collection of dynamic volumes whose accessibility can be prescribed through actions of movement or airspace planning.

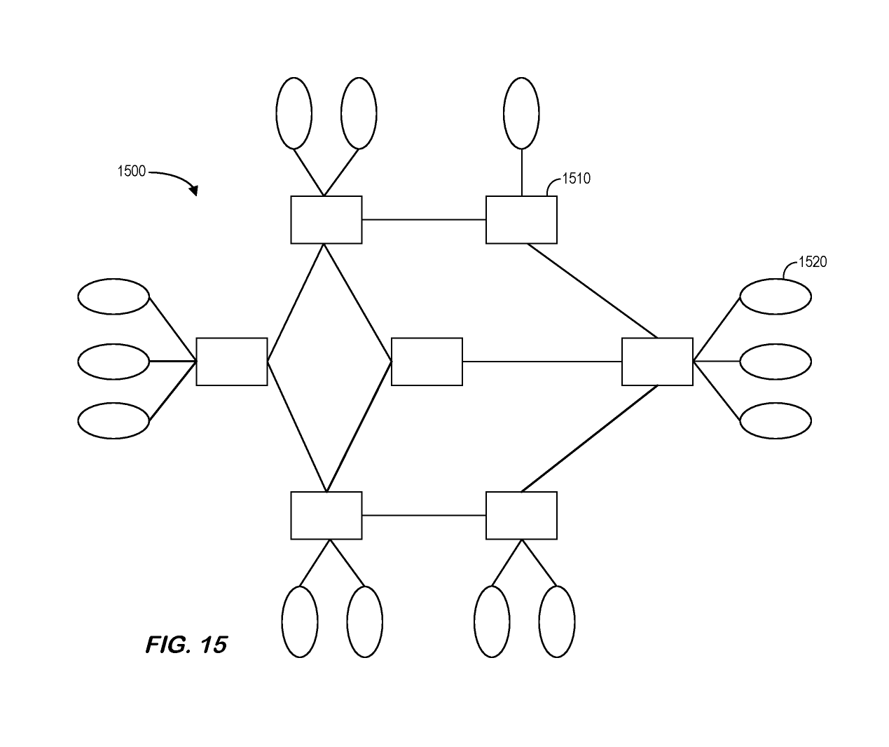

In some embodiments, registry software supports safe operations of unmanned aerial traffic through: (i) dynamic registration of operators, equipage, movement plans, airspaces and their behavioral attributes, and (ii) the validation in real-time of consistency of vehicle actions/dynamics relative to the registered behavior. Note that the illustration of FIG. 6 is logical and each module depicted in the figure may be executed on multiple computing resources, synchronized via the distributed in-memory, short-term storage and synchronization services 620. Moreover, multiple instances of registries can be deployed as a federated system of systems where each registry instance is mapped to a set of specific geo-political administrative domains (as described with respect to FIG. 15). In some cases, national or even global airspaces may be divided into multiple domains. Note that a single registry can serve multiple domains and/or a domain can be served by multiple registries.

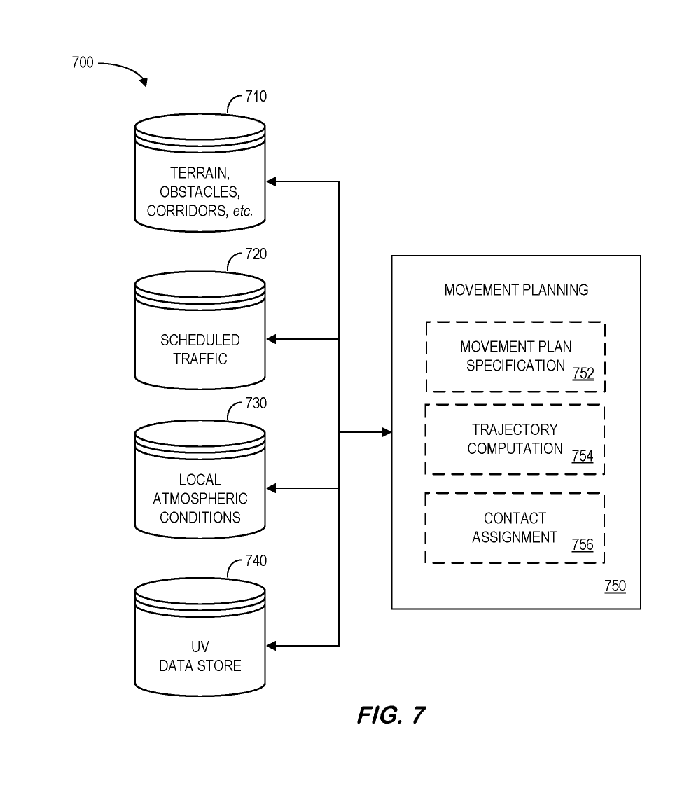

A centralized registry may implement a work flow that takes as input a movement operator request for a movement plan using a movement planning module. For example, FIG. 7 is a system 700 with a movement planning module 750 or engine according to some embodiments. The movement planning module 750 may access a data set 710 storing terrain information, obstacles information, corridor definitions, airspace constraints, etc. By way of example, this data set might store: (a) terrain elevation models; (b) vertical obstacles such as towers and buildings; (c) corridors such as airspaces above specific terrestrial features such highways, rivers, and unpopulated or sparsely populated areas; (d) airspace constraints such as airspaces above certain geographies over which UV traffic may be temporarily or permanently restricted, etc. Any or all of information in this data set might be imported into the system 700 from external data service providers and dynamically updated. In some cases, the system 700 may also provide interfaces to upload multi-dimensional raw survey data and/or provide tools and interfaces to let an operator map out terrain, define obstacles, design corridors, specify airspace constraints, etc.

The scheduled traffic data store 720 may contain all of the planned UV traffic over a certain airspace for any given time in the future. The local atmospheric conditions data store 730 may interface with various weather service data providers to store current and predicted atmospheric conditions over any airspace. In the case of an unmanned submarine, the system may instead access ocean current information, tide data, etc. The UV data store 740 may represent a database of UV capabilities and feature sets. This might include, for example, UV weight, size, movement characteristics, maximum airtime, on-board movement control and navigation software, on-board sense-and-avoid capabilities, etc. The UV data store 740 may also map specific UV instances in the marketplace to stored UV capabilities and/or feature sets.

The movement planning module 750 may include a movement plan specification service 752 that allows a movement operator to request a movement plan. A movement plan request might include, for example, a starting location, an ending location, and a series of waypoints specified using geo-coordinates. Further, a movement plan may include timing, maneuvering, and speed constraints on the path's start, end, or middle waypoints. According to some embodiments, each movement plan is associated with a UV type. Once a movement plan request is received by the system 700, it can be logged and a request for movement plan event may be generated. The event may be shared, for example, via the distributed in-memory data grid or other peering external interfaces.

The movement planning module 750 may also include a trajectory computation service 754 that computes airspace volume along a path that meets the input movement plan constraints. The trajectory computation service 754 may also computes a time-window for the UV to be at a specific path-segment, the segment length and time-window both being configurable settings.

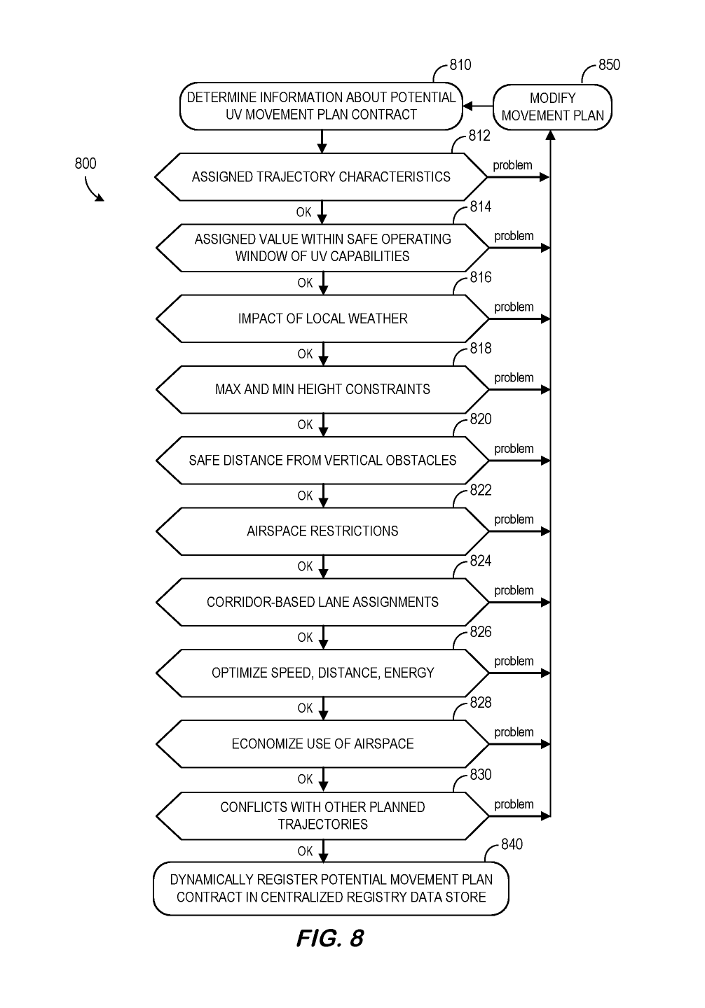

The path, the airspace volume along the path, and/or the timing information may collectively be referred to as a “trajectory.” Note that the system 700 may use several methods to compute a trajectory for a given movement plan. For example, FIG. 8 is a movement planning method 800 in accordance with some embodiments. At 810, the system may determine a potential movement plan contract (e.g., by receiving information about the contract from an operator or planner). The system may then review the assigned trajectory characteristics such as turns, ascend, and descend rates as desired by the operator at 812. If there is a problem at 812, the movement plan may be modified at 850. If the is no problem at 812, the assigned volume is reviewed to ensure it is well within the safe operating window of the given UV capabilities at 814. If there is a problem at 814, the movement plan may be modified at 850.

If the is no problem at 814, the impact of local atmospheric conditions (e.g., wind direction and speed) along the trajectory may be considered at 816. If there is a problem at 816, the movement plan may be modified at 850. If the is no problem at 816, the system may ensure that the trajectory respects the maximum and minimum height constraints for any requested movement plan (also considering the terrain across the path) at 818. If there is a problem at 818, the movement plan may be modified at 850.

If the is no problem at 818, the system may ensure that the trajectory maintains safe distance from vertical obstacles at 820. If there is a problem at 820, the movement plan may be modified at 850. If the is no problem at 820, the system may compare the trajectory against airspace restrictions and any UV operational restrictions that might be in place at 822. If there is a problem at 822, the movement plan may be modified at 850. If the is no problem at 822, the system may consider corridor-based lane assignments at 824 (if specific corridors are in use and applicable for a specific movement plan). If there is a problem at 824, the movement plan may be modified at 850.

If the is no problem at 824, the system may optimize the trajectory path elements in terms of speed, distance, energy consumption, etc. at 826. If there is a problem at 826, the movement plan may be modified at 850. Similarly, if the is no problem at 826, the system may select a trajectory (from a potentially large set of options) to economize use of airspace at 828. If there is a problem at 828, the movement plan may be modified at 850. According to some embodiments, the system may optionally consider the inclusion of contingency paths and maneuvers to allow the unmanned aircraft to accommodate unplanned scenarios during movement.

Finally, if the is no problem at 828, the system may ensure that the potential trajectory is conflict-free with other planned trajectories at 830. That is, no two trajectories should have overlapping airspace volume for an overlapping movement duration. If there is a problem at 830, the movement plan may be modified at 850. If the service cannot find a conflict-free trajectory, it may issue an appropriate warning/error message to the movement operator.

If there is no problem at 830 (that is, all of the requirements described with respect to FIG. 8 have been met), the potential movement path contact may be approved and registered by the centralized registry at 840. For example, upon receiving a conflict-free trajectory generation event, aa contract assignment service may assign and record the conflict-free registry as a contract in the system.

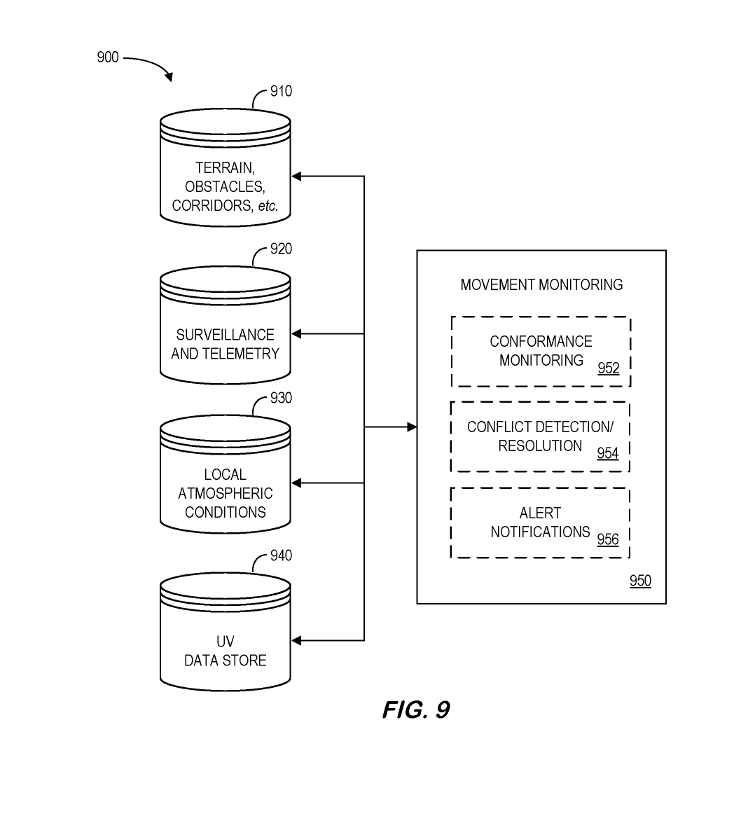

A centralized registry may implement a work flow that offers conformance monitoring and conflict detection and resolution services for safe UV movement operations using a movement monitoring module. For example, FIG. 9 is a system 900 with a movement monitoring module 950 or engine according to some embodiments. The movement monitoring module 950 may access a data set 910 storing terrain information, obstacles information, corridor definitions, airspace constraints, etc., a local atmospheric conditions data store 930, and a UV data store 940 similar to those described with respect to FIG. 7.

The movement monitoring module 950 may also access a surveillance and telemetry data store 920. For example, a service may collect real-time location data from UV systems and store them in this data store 920. Note that the data collection might occur in multiple different ways. For example, the system 900 may provide interfaces so that UV real time location updates can be directly streamed to the system 900 using cellular or satellite communication systems. Optionally, an UV can stream location updates to other relay systems, including ground control stations that have direct communication links to the UV. As another example, the system 900 might ingest location update data streams from other commercial or governmental aggregation services (that might include, for example, telemetry for both manned and unmanned aerial systems).

The movement monitoring module 950 may include a conformance monitoring service to compare UV location update time-series data with the approved contract to ensure conformance. Upon detecting trajectory deviation beyond a contract specification, the system 900 may issue an alert. According to some embodiments, the system 900 may also issue an updated contract that may solve the out-of-conformance problem. Note that the system 900 might be configured such that the alert is issued immediately upon detection of a variation or might instead be set to trigger only when the variation results in a minimum loss of separation between the given UV and another adjacent UV.

The movement monitoring module 950 may also include a conflict detection and resolution service that searches conflicts in movement paths between both manned and unmanned aerials systems that are operating in a common airspace (e.g., conflicts that would likely result in a collision). Note that not all loss of separations might result in a collision, so the system 900 may make a distinction between loss of separation for a short period versus loss of separation that will probably result in a collision in the very near future. Upon detecting a high likelihood of collision, the service 954 may issue an appropriate alert notification with instructions to one or all the parties involved in the loss of separation. According to some embodiments, the system 900 may also issue commands in the form of a revised contract to one or more vehicles associated with the conflict. The instructions might be based, for example, upon the capabilities of the UV involved in the conflict. For example, one UAV might receive course-correction instructions while another receives directives to execute a default evasive maneuver.

The movement monitoring module 950 may also include an alert notifications service that listens for various events raised by other services. Upon detecting a new event, this service 956 may communicate an appropriate notification to the UV based upon how the UV is connected to the registry. According to some embodiments, a UV may be directly connected to the registry software or may be connected via a relay ground station that is in the administrative control of the movement operator.

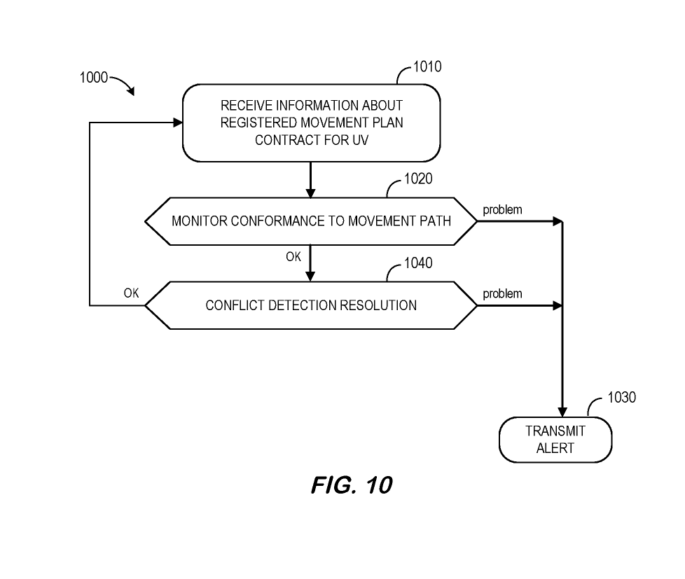

FIG. 10 is a movement monitoring method 1000 in accordance with some embodiments. At 1010, the system may determine information about a registered movement path. At 1020, to system may ensure that a UV is behaving in accordance with the registered movement path. If there is a problem detected at 1020 (e.g., a drone has strayed from a planned route), an alert is issued at 1030. If there is no problem detected at 1020, the system checks to see if there is a probable upcoming conflict between the UV and another piloted or pilotless vehicle. If a problem is detected at 1030, an alert is transmitted at 1040. If no problem is detected at 1030, the method 1000 continues to monitor at 1010.

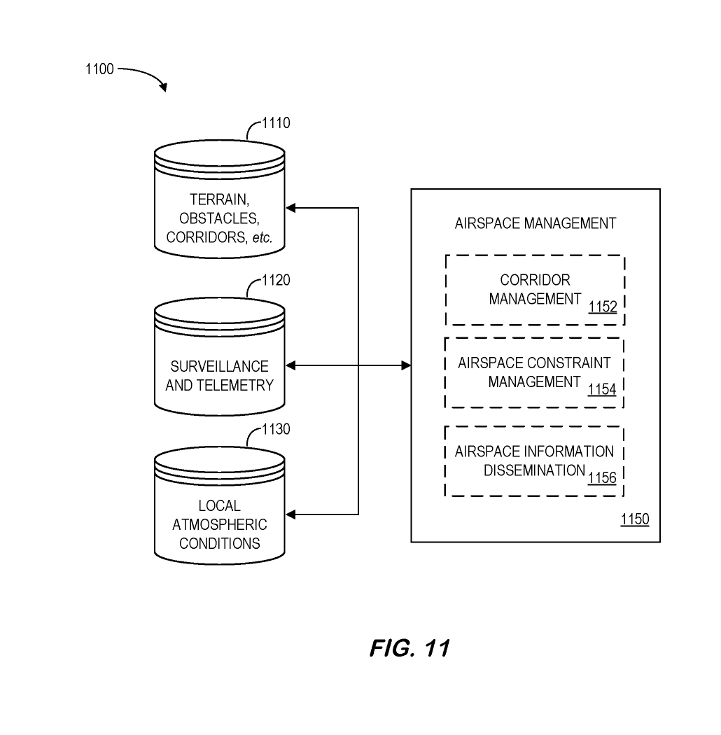

A centralized registry may implement a work flow that manages the lifecycle of corridors, permanent and temporary airspace restrictions, and sharing of the airspace situational awareness with the subscribed users using airspace management module. For example, FIG. 11 is a system 1100 with an airspace management module 1150 or engine according to some embodiments. The airspace management module 1150 may access a data set 1110 storing terrain information, obstacles information, corridor definitions, airspace constraints, etc. and a local atmospheric conditions data store 1130 similar to those described with respect to FIG. 7. The airspace management module may also access a surveillance and telemetry data store 920 similar to the one described with respect to FIG. 9.

The airspace management module 1150 may include a corridor management service 1152 to enable the ingestion of corridor definition from external data sources, the creation of new corridors, and the editing and deleting of existing corridors. As used herein, the term “corridor” might refer to, for example, an airspace above certain terrestrial geometry.

The airspace management module 1150 may also include an airspace constraint management service 1154 used by regulators and asset owners (who may have a right-of-way over the airspace above their assets) to provide temporary or permanent restrictions associated with certain types of UV traffic. For example, an Aviation Authority might prohibit movements in the proximity of public and private airports or may put temporary restrictions on movements over a stadium holding a public event.

The airspace management module 1150 may also include an airspace information dissemination service 1156 associated with terrain, obstacles, corridor definitions, airspace constraints, surveillance and telemetry, and local atmospheric conditions that may be disseminated to movement operators who subscribe to this information. The subscriptions might be, for example, specific to geographic areas and this service 1156 might appropriately push out updates periodically. The frequency of updates might depend on a subscription type. The system 1100 might support, for example, on-demand and batch updates. According to some embodiments, on-demand updates might be pushed out to subscribers as soon as they occur. In contrast, batch updates might be grouped over a configurable period and then pushed out collectively to a subscriber.

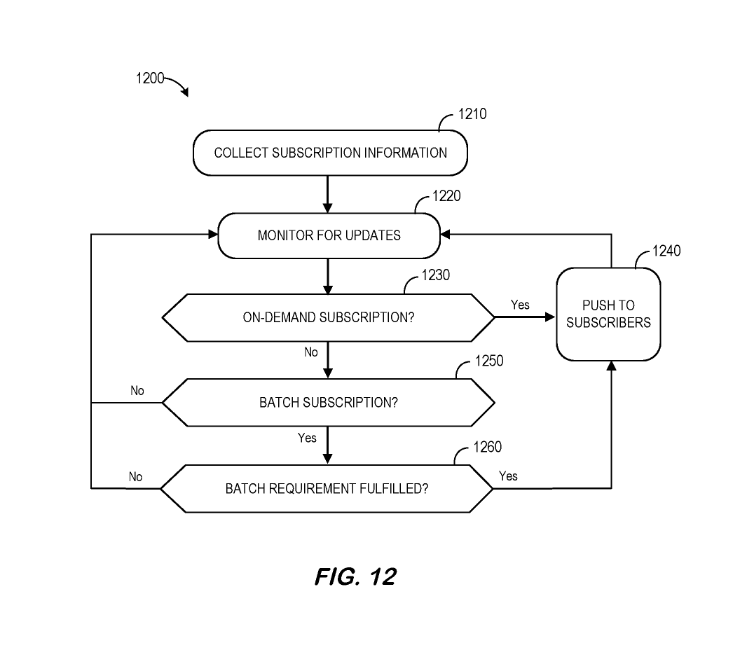

FIG. 12 is an airspace planning method 1200 in accordance with some embodiments. At 1210, the system may collect subscription information (e.g., associated with on-demand and/or batch subscriptions by operators) and monitor for updates at 1220 (e.g., has the weather recently changed?). If a detected update is associated with an “on-demand” subscription at 1230, it may be immediately pushed to the appropriate subscribers at 1240 and the method 1200 continues to monitor for updates at 1220. If the detected update is not associated with an on-demand subscription at 1230, it is determined at 1250 whether the update is associated with a batch subscription. If the update is not associated with a batch subscription at 1250, the method continues to monitor for updates at 1220. If the update is associated with a batch subscription at 1250, it is determined if the appropriate match requirement has been fulfilled (e.g., a pre-determined period of time has passed or a pre-determined number of events have been detected) at 1260. If the batch requirement is not fulfilled at 1260, the method continues to monitor for updates at 1220 (saving the event to be later transmitted as part of a batch of events). If the batch requirement is fulfilled at 1260, the entire batch is pushed to the appropriate subscribers at 1240 and the method 1200 continues to monitor for updates at 1220.

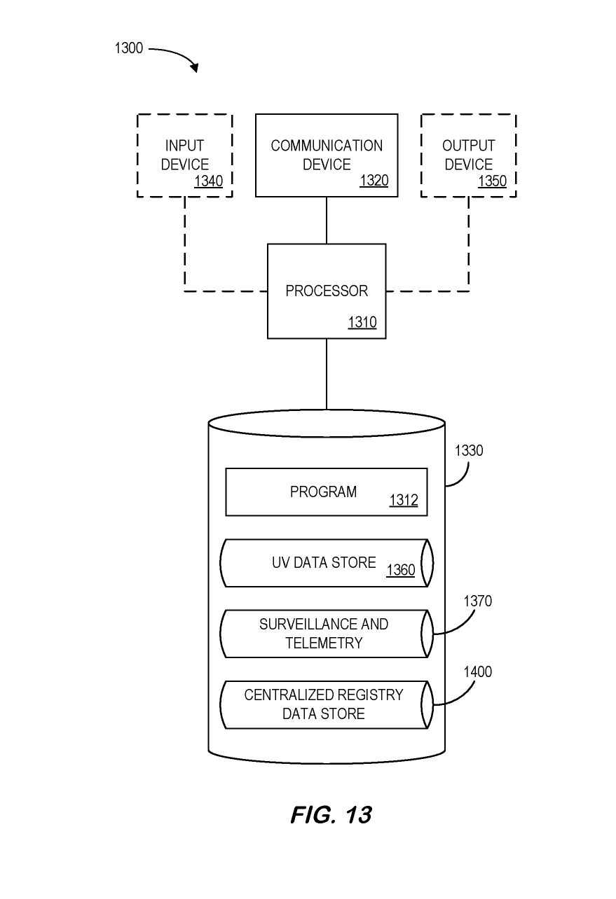

In this way, embodiments described herein may comprise a tool that facilitates the management of UV traffic and may be implemented using any number of different hardware configurations. For example, FIG. 13 illustrates a platform 1300 that may be, for example, associated with the systems 100, 600 of FIGS. 1 and 6, respectively (as well as other systems described herein). The platform 1300 comprises a processor 1310, such as one or more commercially available Central Processing Units (“CPUs”) in the form of one-chip microprocessors, coupled to a communication device 1320 configured to communicate via a communication network (not shown in FIG. 13). The communication device 1320 may be used to communicate, for example, with one or more remote data stores and/or operator interfaces. Note that communications exchanged via the communication device 1320 may utilize security features, such as those between a public internet user and an internal network of an insurance enterprise. The security features might be associated with, for example, web servers, firewalls, and/or PCI infrastructure. The platform 1300 may optionally further include an input device 1340 (e.g., a mouse and/or keyboard to enter information about terrain, corridors, vehicle capabilities, etc.) and an output device 1350 (e.g., to output system reports, generate map displays, transmit alerts, etc.).

The processor 1310 also communicates with a storage device 1330. The storage device 1330 may comprise any appropriate information storage device, including combinations of magnetic storage devices (e.g., a hard disk drive), optical storage devices, mobile telephones, and/or semiconductor memory devices. The storage device 1330 stores a program 1312 and/or network security service tool or application for controlling the processor 1310. The processor 1310 performs instructions of the program 1312, and thereby operates in accordance with any of the embodiments described herein. For example, the processor 1310 may implement a cloud-based, centralized registry data store may contain electronic records that represent movement plan contracts for UVs. The processor 1310 may initially receive information about a potential movement plan contract for a UV and the processor 1310 may dynamically create a potential multi-dimensional, time-indexed volume representing the potential movement plan contract. The processor 1310 may then automatically compare the potential multi-dimensional, time-indexed volume with another volume representing another movement plan contract that was previously registered with the centralized registry platform. Based on a result of the comparison, the 1310 processor may dynamically register the potential movement plan contract in the centralized registry data store.

The program 1312 may be stored in a compressed, uncompiled and/or encrypted format. The program 1312 may furthermore include other program elements, such as an operating system, a database management system, and/or device drivers used by the processor 1310 to interface with peripheral devices.

As used herein, information may be “received” by or “transmitted” to, for example: (i) the platform 1300 from another device; or (ii) a software application or module within the platform 1300 from another software application, module, or any other source.

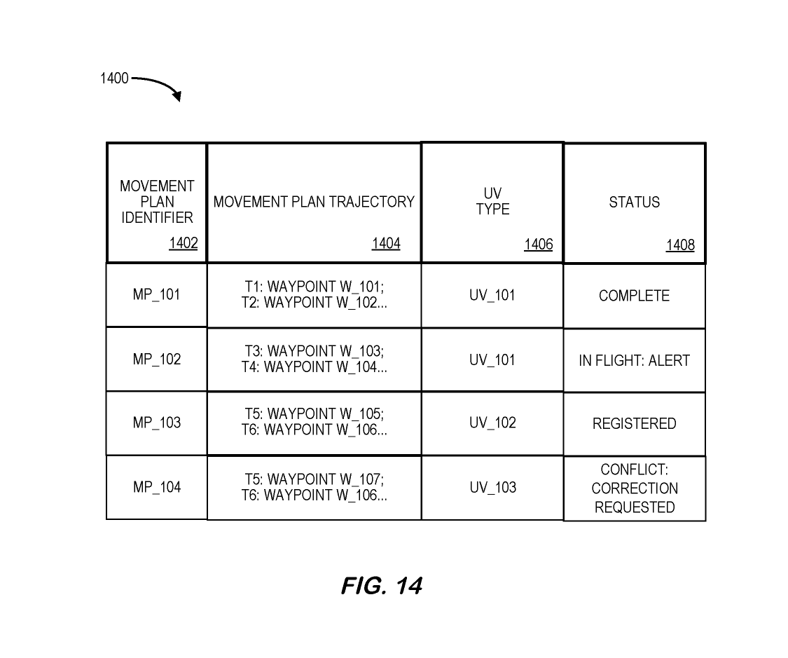

In some embodiments (such as shown in FIG. 13), the storage device 1330 further stores a UV data store 1360, surveillance and telemetry 1370, and a centralized registry data store 1400. An example of a database that might be used in connection with the platform 1300 will now be described in detail with respect to FIG. 14. Note that the database described herein is only an example, and additional and/or different information may be stored therein. Moreover, various databases might be split or combined in accordance with any of the embodiments described herein. For example, the UV data store 1360 and surveillance and telemetry 1370 might be combined and/or linked to each other within the program 1312.

Referring to FIG. 14, a table is shown that represents the centralized registry data store 1400 that may be stored at the platform 1300 in accordance with some embodiments. The table may include, for example, entries identifying movement path contracts. The table may also define fields 1402, 1404, 1406, 1408 for each of the entries. The fields 1402, 1404, 1406 may, according to some embodiments, specify: a movement plan identifier 1402, a movement plan trajectory 1404, a UV type 1406, and a status 1408. The centralized registry data store 1400 may be created and updated, for example, based on information electrically received from operators, data stores, etc.

The movement plan identifier 1402 may be, for example, a unique alphanumeric code identifying a UV trip. According to some embodiments, the centralized registry data store 1400 may further contain identifiers associated with a specific operator. In this case, only an authorized party (e.g., the U.S. Department of Defense) might be allowed to access and/or query the information. The movement plan trajectory 1404 might define the path of the trip, such as by listing a time-indexed series of geographic waypoints or a multi-dimensional ground referenced path. The UV type 1406 might indicate a model or manufacturer of a drone and may, according to some embodiments, be linked to one or more behavioral characteristics of the vehicle (e.g., a maximum or minimum speed). The status 1408 might indicate that the trip is over (“complete”), in movement (and whether or not an alert currently exists), approved and “registered,” determined to be in conflict, etc. For example, in FIG. 14 potential movement plan “FP_104” has been flagged as being in conflict with previously registered movement plan “FP_103” because in both cases the vehicles will be at waypoint W_106 at time T6 (thus making a collision probable).

Some embodiments described herein may incorporate a mechanism to synchronize key information across registries so that safe and efficient UV operations can be realized at a global scale. For example, FIG. 15 is a system 1500 utilizing federated deployment according to some embodiments. The system 1500 includes both authoritative registry instances 1510 (represented by rectangular icons) and client registry instances 1520 (represented by oval icons). Such a system 1500 may provide a deployment scenario with multiple instances of registries and a federation global airspace can be broken up into various geo-political administrative domains. For example, national, state, region, and city level could be one such hierarchical domain breakdown. Each domain may be covered by one or more registry instances and a registry instance may cover multiple domains. Note that not every registry instance needs to execute all the services described herein.

According to some embodiments, authoritative registry instances 1510 may be responsible for one or more geo-political domains and execute all the component registry services described earlier. Since domains may overlap or a domain may be covered by multiple authoritative registries, information important for safe UV operations needs to be synchronized so that a single authoritative view can be presented for movement planning, monitoring, and airspace management. There may be multiple information sharing approaches to realize this synchronization. In some embodiments, this may be accomplished by using a broadcast and publish subscriber information exchange mechanisms as follows:

a) Each authoritative registry is connected, and always stays connected, to at least one other authoritative registry;

b) Each authoritative registry periodically broadcasts its domain of interest, and broadcast messages are propagated using the peering links established in (a);

c) Set of authoritative registries with overlapping domains establish a publish/subscribe link to exchange information using one of many filtering criteria. As an example, the filtering may be based upon geographic regions represented/modeled as circles or polygons; and

d) Using the links established in (c), the authoritative registries may always maintain a consistent view of data related to movement planning, movement monitoring, and dynamic airspace constraints.

According to some embodiments, client registry instances 1520 may interface to an authoritative registry and might not execute the full suite of component registry services described herein. In some cases, they may rely on an appropriate authoritative registry for conflict-free trajectory planning. Besides trajectory planning, these client registries may also subscribe to additional services from an authoritative registry for movement monitoring and airspace constraint management.

By allowing for the federation of multiple authoritative registries, information synchronization approaches including broadcast and publish/subscribe interfaces, and distributed collaboration between client and the corresponding authoritative registry, the system 1500 may achieve a global scale.

Thus, some embodiments described herein may provide technical advantages and enable collaboration between various movement operators and regulatory agencies so that unmanned aerial traffic can be safely regulated and safe unmanned movement operations can be realized. Embodiments may facilitate safe unmanned movement operations as the current approaches for managing air traffic will not scale for the very large number of expected unmanned movements. By providing a method and a system for the distributed collaboration and coordination between movement operators and regulators, embodiments help ensure that airspace can be safely and effectively timeshared.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

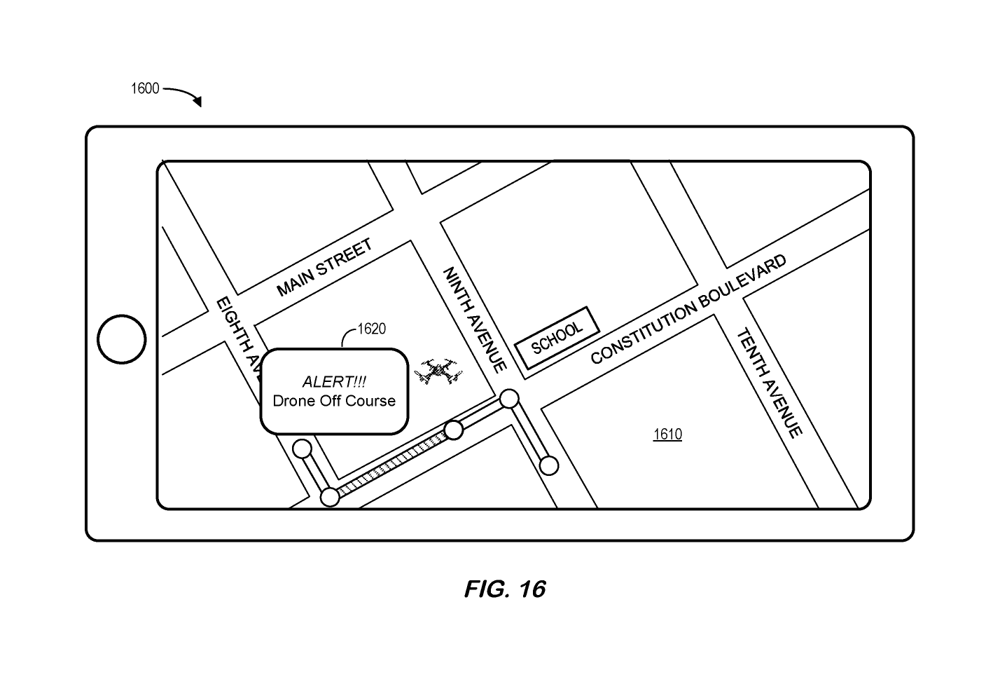

Although specific hardware and data configurations have been described herein, note that any number of other configurations may be provided in accordance with embodiments of the present invention (e.g., some of the information described herein may be combined or stored in external systems). Moreover, although embodiments have been described with respect to specific types of data, note that embodiments might be associated with other types of data, including other type of vehicles, automobiles, submarines, etc. Similarly, the displays shown and described herein are provided only as examples, and other types of displays and display devices may support any of the embodiments. For example, FIG. 16 illustrates a tablet computer 1600 with an interactive UV traffic display 1610 that might utilize a graphical user interface. The display 1610 might show the location of a drone on a street map along with any current alert messages 1620 (e.g., indicating that the drone strayed from a pre-agreed upon path). Note that selection of an element on the display 1610 might result in a display of further information about that element. Moreover, the display 1610 might comprise an interactive user interface (e.g., via a touchscreen) and include one or more icons to let an operator or administrate change various parameters in accordance with any of the embodiments described herein.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. A system to facilitate unmanned vehicle traffic management, comprising:
a centralized registry data store containing electronic records that represent movement plan contracts for Unmanned Vehicles (“UVs”); and
a centralized registry platform, coupled to the centralized registry data store, including:
a communication port to exchange information with a plurality of UV, and
a centralized registry computer processor, coupled to the communication port and the centralized registry data store, adapted to:
receive information about a potential movement plan contract for a UV,
dynamically create a potential multi-dimensional, time-indexed volume representing the potential movement plan contract,
automatically compare the potential multi-dimensional, time-indexed volume with another volume representing another movement plan contract that was previously registered with the centralized registry platform, and
based on a result of the comparison, dynamically register the potential movement plan contract in the centralized registry data store.

2. The system of claim 1, wherein the potential movement plan contract is associated with at least one of: (i) an unmanned aerial system, (ii) a drone, (iii) an autonomous automobile, (iv) a cargo ship, and (v) a submarine.

3. The system of claim 1, wherein the centralized registry platform exchanges information (i) directly with a UV or (ii) with the UV via at least one control system.

4. The system of claim 1, wherein the dynamically registered movement plan contract includes at least one of: (i) an operator identifier, (ii) an equipment identifier, (iii) movement plan locations, (iv) an airspace identifier, and (v) behavioral attributes.

5. The system of claim 1, wherein the centralized registry further facilitates validation, in substantially real-time, of consistency of vehicle actions and dynamics relative to registered behavior.

6. The system of claim 1, wherein the centralized registry platform utilizes distributed, in-memory data grid short-term storage and synchronization services.

7. The system of claim 1, wherein the centralized registry platform is associated with a movement planning engine that exchanges information with at least one of: (i) a terrain, obstacle, corridor, or airspace constraint data store, (ii) a scheduled traffic data store, (iii) a local atmospheric conditions data store, and (iv) a UV database.

8. The system of claim 7, wherein the movement planning engine executes at least one of: (i) a movement plan specification process, (ii) a trajectory computation process, and (iii) a contract assignment process.

9. The system of claim 1, wherein the centralized registry platform is associated with a movement monitoring engine.

10. The system of claim 9, wherein the movement monitoring engine exchanges information with at least one of: (i) a terrain, obstacle, corridor, or airspace constraint data store, (ii) a surveillance and telemetry data store, (iii) a local atmospheric conditions data store, and (iv) a UV database.

11. The system of claim 9, wherein the movement planning engine executes at least one of: (i) a conformance monitoring process, (ii) a conflict detection and resolution process, (iii) an alert notification process, and (iv) a movement path contract update process.

12. The system of claim 1, wherein the centralized registry platform is associated with an airspace management engine.

13. The system of claim 12, wherein the airspace management engine exchanges information with at least one of: (i) a terrain, obstacle, corridor, or airspace constraint data store, (ii) a surveillance and telemetry data store, and (iii) a local atmospheric conditions data store.

14. The system of claim 12, wherein the airspace management engine executes at least one of: (i) a corridor management process, (ii) an airspace constraint management process, and (iii) an airspace information dissemination process.

15. The system of claim 1, wherein multiple instances of the registry are deployed via a federated system of services.

16. The system of claim 15, wherein each registry instance is mapped to a set of geo-political administrative domains.

17. A computer-implemented method to facilitate unmanned vehicle traffic management, comprising:
receiving, at a centralized registry platform, information about a potential movement plan contract for an Unmanned Vehicle (“UV”);
dynamically creating a potential multi-dimensional, time-indexed volume representing the potential movement plan contract;
automatically comparing the potential multi-dimensional, time-indexed volume with another volume representing another movement plan contract that was previously registered with the centralized registry platform; and
based on a result of the comparison, dynamically registering the potential movement plan contract in the centralized registry data store, wherein the centralized registry data store contains electronic records that represent movement plan contracts for UVs.

18. The method of claim 17, wherein the centralized registry platform is associated with: (i) a movement planning engine, (ii) a movement monitoring engine, and (iii) an airspace management engine.

19. The method of claim 18, wherein the centralized registry platform exchanges information with at least one of: (i) a terrain, obstacle, corridor, or airspace constraint data store, (ii) a scheduled traffic data store, (iii) a local atmospheric conditions data store, (iv) a UV database, and (v) a surveillance and telemetry data store.

20. A non-transitory, computer-readable medium storing program code, the program code executable by a computer processor of a centralized registry platform to cause the platform to perform a method comprising:
receiving information about a potential movement plan contract for an Unmanned Vehicle (“UV”);
dynamically creating a potential multi-dimensional, time-indexed volume representing the potential movement plan contract;
automatically comparing the potential multi-dimensional, time-indexed volume with another volume representing another movement plan contract that was previously registered with the centralized registry platform; and
based on a result of the comparison, dynamically registering the potential movement plan contract in the centralized registry data store, wherein the centralized registry data store contains electronic records that represent movement plan contracts for UVs.

21. The medium of claim 20, wherein the centralized registry platform is associated with: (i) a movement planning engine, (ii) a movement monitoring engine, and (iii) an airspace management engine.

22. The medium of claim 20, wherein the centralized registry platform exchanges information with at least one of: (i) a terrain, obstacle, corridor, or airspace constraint data store, (ii) a scheduled traffic data store, (iii) a local atmospheric conditions data store, (iv) a UV database, and (v) a surveillance and telemetry data store.
